(19) United States
(12) Patent Application Publication
(10) Pub. No.: US 2003/0229579 A1
(43) Pub. Date: Dec. 11, 2003

(54) Simultaneous comparison of mortgage information and asset accumulation information

(76) Inventors: David T. Savage, Newport Beach, CA (US); Gregory S. Wexler, Encino, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/166,494

(22) Filed: Jun. 10, 2002

(51) Int. Cl. G06F 17/60

(52) U.S. Cl. 705/38

(57) ABSTRACT

A computer-implemented method of assisting a consumer in deciding whether to prepay his/her loan comprises first determining total loan cost reduction due to the prepayment or prepayments. Second, a return on investment resulting from investing the prepayment or prepayments is estimated. Finally, the consumer is provided with a side-by-side comparison of the total loan cost reduction and the estimated return on investment.

### BACKGROUND OF THE INVENTION

1. Field of the Invention

The present invention relates generally to systems for comparing financial information, and relates specifically to systems for comparing loan terms with asset accumulation data.

2. Description of the Related Art

Consumers who wish to borrow money are faced with an overwhelming variety of loan options. This is particularly true in the field of home mortgages, where prospective borrowers must evaluate a variety of loans, all of which may have different points, interest rates, down payments, and repayment periods. While the wide variety of loan options increases the likelihood that a particular prospective borrower will find a loan that closely matches his/her particular requirements, such wide variety can also cause the prospective borrower to be overwhelmed with information regarding the loan terms available. To compound this problem of “information overload”, the broader financial consequences of a prospective borrower's various loan options are often presented in isolation from the prospective borrower's other financial considerations and investment options.

For example, in a typical home mortgage, a borrower must decide, among other things, whether to pay any “points”. A point is a fixed administrative fee paid to the loan servicer upon loan origination or disbursement; it is applied to neither outstanding principal nor interest. Points are usually paid in exchange for a reduced interest rate over the term of the loan. While payment of points increases the initial cost of the loan, the resultant reduction in interest rate causes the borrower's monthly payments to be reduced, thereby resulting in a monthly savings that extends over the life of the loan. If this monthly savings is used to prepay the loan (i.e., if it is paid towards reduction of the loan principal each month), the loan can be paid off early, thereby reducing the overall cost of the loan. It is common for loan officers to report the interest savings that can be realized from loan prepayment to their potential customers.

However, instead of using the monthly savings derived from payment of points to prepay the loan, a borrower may instead wish to invest his monthly savings independently. By consistently investing the monthly savings over the life of the loan, a significant accumulation of assets can be accomplished. This investment-over-time process is commonly referred to as “asset accumulation”. It is common for investment advisors to report the quantity of assets that can be accumulated by investing a fixed sum on a monthly basis over a period of time.

In certain circumstances, the amount of assets a borrower may accumulate by investing his monthly savings over the life of the loan may exceed the borrower's total loan cost savings realized by prepaying the loan on a monthly basis. However, to make this comparison, a prospective borrower must first visit his loan officer to determine his/her potential interest savings from prepayment, and then the prospective borrower must visit his/her investment advisor to determine his potential asset accumulation. Each time the potential loan terms change, the prospective borrower must revisit each of these professionals in what could likely be an expensive and time consuming process.

Thus, a method for simultaneously providing a prospective borrower both loan prepayment interest savings information and asset accumulation information is desired. The various embodiments of the system for simultaneous comparison of mortgage information and asset accumulation information described herein address this desire.

### SUMMARY OF THE INVENTION

In one aspect of the present invention, a computer-implemented method of assisting a consumer in deciding whether to prepay his/her loan comprises first determining total loan cost reduction due to a prepayment or a series of prepayments. Second, a return on investment resulting from investing the prepayment or series of prepayments is estimated. Finally, the consumer is provided with a comparison of the total loan cost reduction and the estimated return on investment.

In another aspect of the present invention, a computer-implemented method comprises collecting loan information and investment information associated with a user. The method further comprises calculating monthly savings information based on the loan information. The method further comprises calculating interest savings information based on the monthly savings information and the loan information. The method further comprises calculating asset accumulation information based on the monthly savings information and the investment information. The method further comprises providing the user with a comparison of the interest savings information and the asset accumulation information.

In yet another aspect of the present invention, a computer-implemented system comprises a program module configured to collect loan information and investment information associated with a user. The system further comprises a program module configured to calculate monthly savings information based on the loan information. The system further comprises a program module configured to calculate interest savings information based on the monthly savings information and the loan information. The system further comprises a program module configured to calculate asset accumulation information based on the monthly savings information and the investment information. The system further comprises a program module configured to provide the user with a comparison of the interest savings information and the asset accumulation information.

### BRIEF DESCRIPTION OF THE DRAWING

The illustrative embodiments described herein may be best described with reference to the accompanying drawing. The drawing is for ease of explanation of the basic teachings of the illustrative embodiments only.

FIG. 1 is a flowchart illustrating one embodiment of the system for simultaneous comparison of mortgage information and asset accumulation information.

### DETAILED DESCRIPTION OF THE PREFERRED EMBODIMENTS

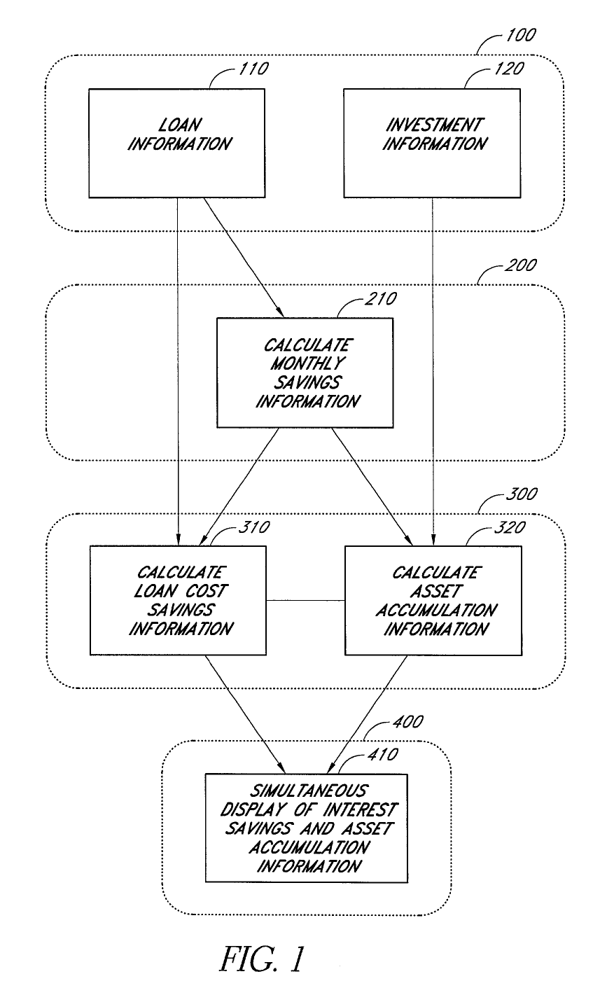

FIG. 1 is a flowchart illustrating one embodiment of a computer-implemented method of assisting a consumer in deciding whether to prepay a loan or to independently invest the money that would otherwise be prepaid to the loan. The method comprises an information collection step 100, a monthly savings calculation step 200, an aggregate savings calculation step 300 and a display step 400.

Again referring to the embodiment illustrated in FIG. 1, the information collection step 100 further comprises a loan information collection step 110 and an investment information collection step 120. In certain embodiments, the loan information collection step 110 comprises collecting a variety of information about a prospective loan or an existing loan. For example, in certain embodiments, information that is collected in the loan information collection step 110 includes amount of principal borrowed, interest rate, number of “points” paid and repayment period. (A “point” is a fixed administrative fee paid to the loan servicer upon loan origination or disbursement; it is usually applied to neither outstanding principal nor interest.) However, in other embodiments, other loan information that is particularly relevant to a particular application or individual is collected. In certain embodiments, the loan information may be collected directly from the user, such as through prompts for input in a user interface. However, in other embodiments, the loan information collection step 110 is automated by collecting the desired information from an information source such as a database or an internet service. After collection, the loan information is stored in any computer-readable medium, such as on a hard disk or in memory modules.

The investment information collection step 120 likewise comprises collecting a variety of information about a consumer and his/her investment options. For example, in certain embodiments, information that is collected in the investment information collection step 120 includes historical rate-of-return data for a variety of investments available to a consumer and information regarding investment qualifications for various investment vehicles. However, in other embodiments, other investment information that is particularly relevant to a particular application or individual is collected. In certain embodiments, the investment information may be collected directly from the user, such as through prompts for input in a user interface. However, in other embodiments, the investment information collection step 120 is automated by collecting the desired information from an information source such as a database or an internet service. In still other embodiments, the investment information is provided with the assistance of a professional financial advisor. After collection, the investment information is stored in any computer-readable medium, such as on a hard disk or in memory modules.

Again referring to the embodiment illustrated in FIG. 1, the monthly savings calculation step 200 further comprises determining an amount of surplus money that a borrower or prospective borrower (hereinafter collectively referred to as “borrower” for clarity) has available on a monthly basis in operational block 210. As indicated in FIG. 1, in certain embodiments, such an amount of surplus money is partially dependent on the loan information collected in loan information collection step 110.

For example, in certain embodiments, the borrower may have an amount of surplus money available each month by virtue of his/her having paid points upon origination of the loan. Specifically, a borrower will usually pay points in exchange for a reduced interest rate over the term of the loan. A borrower's monthly payment P is given by

$$P = \frac{{Cr ( 1 + \frac{r}{12} )}^{n}}{12} \times \frac{1}{{( 1 + \frac{r}{12} )}^{n} - 1} ,$$

where:

C=the total loan principal borrowed,

r=the annual interest rate, assuming monthly compounding, and

n=the loan term, in months.

Therefore, a reduction in interest rate causes the borrower's monthly payments to be reduced, thereby resulting in a monthly savings that extends over the life of the loan. Operational block 210 comprises calculating this monthly savings based on the loan information collected in loan information collection step 110.

For example, on a loan of $300,000 with a 360 month repayment period, Borrower A, who has a 7.5% interest rate, will have a monthly payment of $2098. In contrast, Borrower B, who pays points to have his/her interest rate reduced to 7.25%, will have monthly payments of $2047 when borrowing the same principal for the same loan term. Thus, in this example, Borrower B has realized a monthly savings of $51 by virtue of his/her payment of points. This is one example of the calculation conducted in operational block 210.

In other embodiments, the monthly savings information may be independent of the loan information collected in loan information collection step 110. For example, during the repayment period of a loan, a borrower may receive an increased salary at her/her job, thereby effectively providing the borrower with an amount of surplus money available on a monthly basis. In such embodiments, the monthly savings information is determined on the basis of additional information collected from the borrower.

One of ordinary skill in the art will recognize that the monthly savings information need not be calculated on a monthly basis. In alternative embodiments, the monthly savings information is determined on a weekly, quarterly or annual basis.

Again referring to the embodiment illustrated in FIG. 1, the aggregate savings calculation step 300 further comprises a loan cost savings calculation step 310 and a asset accumulation calculation step 320. In certain embodiments, the loan cost savings calculation step 310 further comprises calculating a loan cost savings over the term of the loan based on the monthly savings information calculated in operational block 210. As explained above, a borrower will realize a monthly savings if, among other things, s/he can obtain a reduced interest rate (i.e., by virtue of payment of points). If the borrower uses this monthly savings to prepay principal each month, the loan can be paid off early. Early payoff reduces the overall amount of interest paid over the life of the loan, and therefore reduces the total cost of the loan. In such embodiments, this reduction in total cost of the loan is calculated in loan cost savings calculation step 310.

For example, consider Borrower B of the previous example, who has a $300,000 mortgage with a repayment period of thirty years and an interest rate of 7.25%. Borrower B's monthly payment is $2047. Over the 30-year term of Borrower B's loan repayment, Borrower B will pay $436,749 in interest payments, which represents Borrower B's total loan cost. However, if Borrower B uses his/her monthly savings of $51 (as compared to Borrower A, whose 7.5% interest rate requires him to make monthly payments of $2098) to prepay principal each month, Borrower B will pay $395,026 in interest payments. Thus, by using his/her monthly savings of $51 to prepay principal each month, Borrower B will realize a net interest savings of, and will reduce his/her total loan cost by, $41,723. This is one example of the calculation conducted in loan cost savings calculation step 310.

In certain embodiments, asset accumulation step 320 illustrated in FIG. 1 further comprises calculating the value of series of investment contributions using the investment information obtained in investment information collection step 120 and the monthly savings information obtained in operational block 210. Specifically, the borrower may elect not to use his/her monthly savings prepay principal, but instead may elect to invest that monthly savings each month. Asset accumulation step 320 estimates the total value of the borrower's monthly savings, if those monthly savings are consistently invested each month at an estimated rate of return. In such embodiments, the estimated rate of return is determined based on the investment information collected in investment info collection step 120. The future value FV of a series of n monthly periodic investments of value p at a fixed annual interest rate i (assuming monthly compounding) for n months is given by

$$FV = \frac{12 p ( {( 1 + \frac{i}{12} )}^{n} - 1 )}{i} .$$

Further consideration of the previously discussed hypothetical Borrower B will prove instructive. Borrower B's reduced interest rate of 7.25% afforded him/her an extra $51 per month, as compared to Borrower A, whose loan had a 7.5% interest rate. If Borrower B consistently invested this $51 monthly surplus in an investment yielding a 5% rate of return over the course of the 30-year loan, Borrower B would have $42,445 in his/her investment account when repayment of the loan is complete. This is one example of the calculation conducted in asset accumulation step 320.

Again referring to the embodiment illustrated in FIG. 1, the display step 400 further comprises outputting a comparison of the amount by which the total cost of the loan is reduced with the return on investment in operational block 410. The amount by which the total cost of the loan is determined in loan cost savings calculation step 310, and the return on investment is determined in asset accumulation calculation step 320. In certain embodiments, the output of the aforementioned comparison is provided on a video display, while in other embodiments, such comparison output is provided on a hardcopy via a printer. In such embodiments, the borrower can simultaneously compare his/her overall financial position if s/he elects to make principal prepayments with his/her overall financial position if s/he elects to regularly invest his/her monthly surplus.

The chart below illustrates one embodiment of the output of display step 400. The data contained in this chart are based on the aforementioned hypothetical Borrower B.

| Loan Cost Savings | Asset Accumulation |
|---|---|
| (interest savings over 30 years) | (accrued assets over 30 years) |
| $41,723 | $42,445 |
| This assumes a monthly savings of | This assumes that 360 monthly |
| $51 is used to prepay principal | savings payment of $51 are regularly |
| each month on a 30-year, $300,000 | invested in an investment vehicle |
| loan with a 7.25% interest rate. | that provides a fixed annual rate |
| | of return of 5%. |

The above chart provides Borrower B with a side-by-side comparison of loan cost savings information and asset accumulation information. In other embodiments, this side-by-side comparison is presented to the borrower as part of a user interface. In such embodiments, the user interface is adapted to allow the system to collect updated information from the borrower, and to present the borrower with corresponding updated loan cost savings information and asset accumulation information. For example, the borrower may wish to investigate how a change in his/her interest rate, repayment term or estimated return on investment effects the loan cost savings information and the asset accumulation information.

Display step 400 eliminates the need for the buyer to visit separate financial professionals to obtain loan cost savings information and asset accumulation information for given loan terms. Providing the borrower with a side-by-side comparison of this information facilitates the borrower's thorough evaluation of a variety of different loan terms. In addition, such a comparison allows the borrower to evaluate the financial consequences of particular loan terms while also considering the borrower's other financial considerations and investment options.

Scope of the Invention

The foregoing presents a description of certain preferred embodiments of a system for simultaneous comparison of mortgage information and asset accumulation information, and of the manner and process of using it, in such full, clear, concise and exact terms as to enable any person of ordinary skill in the art to which it pertains to make and use such a system. This system is, however, susceptible to modifications and alternate configurations from those discussed above which are fully equivalent. Consequently, it is not the intention to limit this system to the particular embodiments disclosed herein. On the contrary, the intention is to cover all modifications and alternate configurations coming within the spirit and scope of the system as generally expressed by the following claims, which particularly point out and distinctly claim the subject matter of the system for simultaneous comparison of mortgage information and asset accumulation information.

What is claimed is:

1. A computer-implemented method of assisting a consumer in deciding whether to make one or more optional prepayments on a loan, the method comprising:
determining an amount by which a total cost of the loan is reduced due to one or more optional prepayments on the loan,
predicting an estimated return on investment resulting from investing the one or more optional prepayments, and
outputting a comparison of the amount by which the total cost of the loan is reduced with the return on investment.

2. The method of claim 1, wherein the total cost of the loan comprises a total amount of interest paid during repayment of the loan.

3. The method of claim 2, wherein the total cost of the loan further comprises a point payment.

4. The method of claim 1, wherein the total cost of the loan is reduced by prepayment of principal on a periodic basis.

5. The method of claim 4, wherein the periodic basis is a monthly basis.

6. The method of claim 1, wherein the estimated return on investment is predicted using market historical data.

7. The method of claim 1, wherein the comparison is provided on a display unit as part of a graphical user interface.

8. The method of claim 1, wherein the comparison is a side-by-side comparison.

9. A computer-implemented method comprising:
collecting loan information and investment information associated with a user,
calculating monthly savings information based on the loan information,
calculating interest savings information based on the monthly savings information and the loan information,
calculating asset accumulation information based on the monthly savings information and the investment information, and
providing the user with a comparison of the interest savings information and the asset accumulation information.

10. The method of claim 9, wherein the loan information is selected from the group consisting of: loan principal amount, loan interest rate, interest compounding period, loan repayment period and points paid.

11. The method of claim 9, wherein the investment information is historical market performance information.

12. The method of claim 9, wherein the loan information and the investment information are collected from the user.

13. The method of claim 9, wherein the loan information and the investment information are collected from a database.

14. The method of claim 9, wherein the monthly savings information comprises an amount saved on a monthly basis due to payment of a point.

15. The method of claim 9, wherein the interest savings information comprises an amount saved during repayment of a loan due to a series of principal prepayments.

16. The method of claim 9, wherein the asset accumulation information comprises an amount accrued due to a series of payments to an investment account.

17. The method of claim 9, wherein the comparison is provided on a display unit as part of a graphical user interface.

18. The method of claim 9, wherein the comparison is a side-by-side comparison.

19. The method of claim 9, further comprising:
collecting revised loan information and revised investment information based on the comparison, and
providing the user with a revised comparison based on the revised loan information and revised investment information.

20. A computer-implemented system comprising:
a program module configured to collect loan information and investment information associated with a user,
a program module configured to calculate monthly savings information based on the loan information,
a program module configured to calculate interest savings information based on the monthly savings information and the loan information,
a program module configured to calculate asset accumulation information based on the monthly savings information and the investment information, and
a program module configured to provide the user with a comparison of the interest savings information and the asset accumulation information.

21. The system of claim 20, wherein the loan information is selected from the group consisting of: loan principal amount, loan interest rate, interest compounding period, loan repayment period and points paid.

22. The system of claim 20, wherein the investment information is historical market performance information.

23. The system of claim 20, wherein the loan information and the investment information are collected from the user.

24. The system of claim 20, wherein the loan information and the investment information are collected from a database.

25. The system of claim 20, wherein the monthly savings information comprises an amount saved on a monthly basis due to payment of a point.

26. The system of claim 20, wherein the interest savings information comprises an amount saved during repayment of a loan due to a series of principal prepayments.

27. The system of claim 20, wherein the asset accumulation information comprises an amount accrued due to a series of payments to an investment account.

28. The system of claim 20, wherein the comparison is provided on a display unit as part of a graphical user interface.

29. The system of claim 20, wherein the comparison is a side-by-side comparison.

30. The system of claim 20, further comprising:
a program module configured to collect revised loan information and revised investment information based on the comparison, and
a program module configured to provide the user with a revised comparison based on the revised loan information and revised investment information.
